(19) United States
(12) Patent Application Publication
(10) Pub. No.: US 2025/0252529 A1
(43) Pub. Date: Aug. 7, 2025

(54) IMAGE PROCESSING APPARATUS AND CONTROL METHOD THEREOF

(71) Applicant: CANON KABUSHIKI KAISHA, Tokyo (JP)

(72) Inventors: MICHINORI NAKAJIMA, Kanagawa (JP); KOICHI MURATA, Tokyo (JP)

(21) Appl. No.: 19/036,183

(22) Filed: Jan. 24, 2025

(30) Foreign Application Priority Data
Feb. 1, 2024 (JP) 2024-014417

(51) Int. Cl. G06T 3/40; G06T 7/10

(52) U.S. Cl. CPC G06T 3/40; G06T 7/10; G06T 2207/20132

(57) ABSTRACT

An image processing apparatus includes a first crop circuit capable of cutting out a partial area of an input image and outputting the cut-out partial area, a second crop circuit capable of cutting out the partial area of the input image and outputting the cut-out partial area, and an enlargement circuit configured to enlarge the area cut out by the first crop circuit or the second crop circuit, wherein, in a case where transition is performed from a first state where the enlargement circuit is used with the first crop circuit to a second state where the enlargement circuit is used with the second crop circuit, the first crop circuit cuts out, from the input image, an area having a predetermined size and including an area cut out by the first crop circuit in the first state, and outputs the cut-out area having the predetermined size.

### BACKGROUND OF THE INVENTION

### Field of the Invention

The present invention relates to an image processing apparatus and a control method thereof, and more particularly, to a technique of performing image output using a crop function and image output using a Magnify function.

### Description of the Related Art

The crop function of cutting out a part of an image includes two types of functions: a “simple crop function of cutting out any 2K area from a 4K image” and a “crop zoom function of cutting out any area from a 4K image and resizing the cut-out area to a 2K image”. Further, as an auxiliary function of focus adjustment, there is a “Magnify function of cutting out any area from a 4K image and resizing the cut-out area to a 2K image”. As the crop zoom function and the Magnify function have the same operations as each other but different applications from each other, an imaging apparatus having both the crop zoom function and the Magnify function also exists.

JP 2020-48191 A discloses a technique related to a crop function. In the technique disclosed in JP 2020-48191 A, a simple crop function is used when zoom magnification is on a wide side, and a crop zoom function is used when the zoom magnification is on a tele side.

In studio shooting, it is conceivable to acquire an on-air image using the crop zoom function and acquire an image for focus adjustment using a Magnify function while shooting an entire studio at 4K. Each of the on-air image and the image for focus adjustment is, for example, an image obtained by cutting out a part of a 4K area and resizing the cut-out area to 2K. Areas cut out from the on-air image and the image for focus adjustment may be different from each other.

It is also conceivable that a first image corresponding to a first area and a second image corresponding to a second area are acquired as images to be output to a switcher equipment by using the crop zoom function, and the switcher equipment switches the on-air image between the first image and the second image.

As described above, there is a case where a plurality of processing procedures using the crop zoom function or the Magnify function in each processing procedure is desired to be performed in parallel. When a plurality of resizing circuits are used, such a plurality of processing procedures can be performed in parallel, but a circuit scale increases. In recent years, since a scale of one resizing circuit is increasing along with an increase in resolution of an image to be captured, the increase in the circuit scale by using a plurality of resizing circuits is significantly large. Furthermore, a space in which a circuit can be mounted is being reduced along with downsizing of various devices such as an imaging apparatus, and thus there is a case where a plurality of resizing circuits cannot be mounted. In addition, even if the resizing processing is performed by a general-purpose circuit or software processing instead of a dedicated circuit, a processing load is applied by the resizing processing, and thus there is a case where the resizing processing cannot be simultaneously performed on a plurality of images.

### SUMMARY OF THE INVENTION

The present invention provides a technique capable of appropriately executing processing that requires cutout processing and resizing processing, such as a crop zoom function or a Magnify function, even if the resizing processing is limited.

A first image processing apparatus according to the present invention includes a first crop circuit capable of cutting out a partial area of an input image and outputting the cut-out partial area, a second crop circuit capable of cutting out the partial area of the input image and outputting the cut-out partial area, and an enlargement circuit configured to be used with one of the first crop circuit and the second crop circuit, and enlarge the area cut out by the first crop circuit or the second crop circuit, wherein, in a case where transition is performed from a first state where the enlargement circuit is used with the first crop circuit to a second state where the enlargement circuit is used with the second crop circuit, the first crop circuit cuts out, from the input image, an area having a predetermined size and including an area cut out by the first crop circuit in the first state, and outputs the cut-out area having the predetermined size.

A second image processing apparatus according to the present invention includes a first crop circuit capable of cutting out a partial area of an input image and outputting the cut-out partial area, a second crop circuit capable of cutting out the partial area of the input image and outputting the cut-out partial area, and an enlargement circuit configured to be used with one of the first crop circuit and the second crop circuit, and enlarge the area cut out by the first crop circuit or the second crop circuit, wherein, in a case where transition is performed from a first state where the area cut out by the first crop circuit is enlarged by the enlargement circuit and output to an external device to a second state where the enlargement circuit is used with the second crop circuit, the first crop circuit outputs an image including the area cut out by the first crop circuit in the first state such that the area is identifiable.

Further features of the present invention will become apparent from the following description of exemplary embodiments with reference to the attached drawings.

### BRIEF DESCRIPTION OF THE DRAWINGS

FIG. 1 is a block diagram illustrating a configuration of an imaging apparatus;

FIG. 2 is a schematic diagram illustrating a flow of image data in the imaging apparatus;

FIG. 3 is a schematic diagram illustrating a specific example of a partial enlargement function;

FIG. 4 is a schematic diagram illustrating a flow of image data in the imaging apparatus;

FIG. 5 is a schematic diagram illustrating a specific example of processing of a crop circuit;

FIG. 6 is a schematic diagram illustrating a flow of image data in the imaging apparatus;

FIG. 7 is a schematic diagram illustrating a specific example of processing of the crop circuit and an OSD generation circuit;

FIG. 8A is a flowchart of image output processing;

FIG. 8B is a flowchart of crop zoom setting change processing;

FIG. 8C is a flowchart of Magnify setting change processing;

FIG. 9 is a schematic diagram illustrating a specific example of an operation of the imaging apparatus; and

FIG. 10 is a schematic diagram illustrating a specific example of an operation of the imaging apparatus.

### DESCRIPTION OF THE EMBODIMENTS

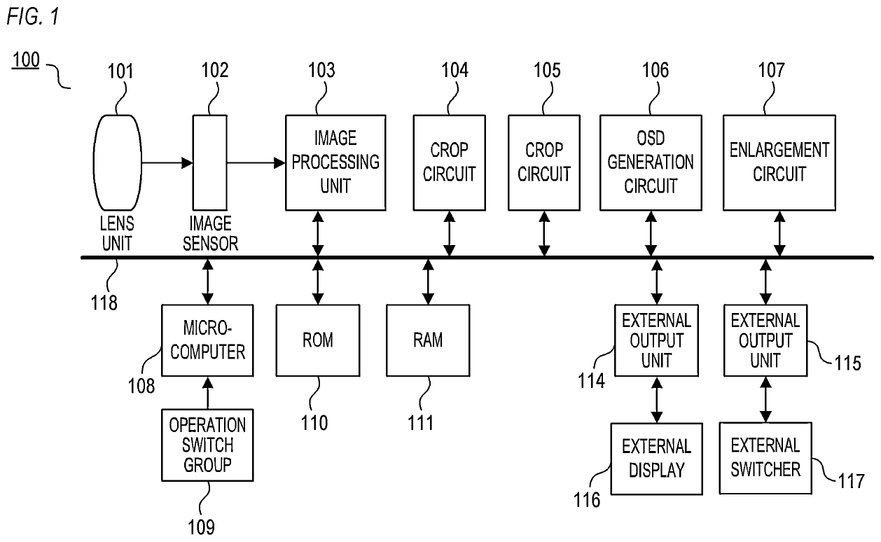

Hereinafter, embodiments of the present invention will be described. FIG. 1 is a block diagram illustrating a configuration of an imaging apparatus 100 as an example of an apparatus to which the present invention can be applied (image processing apparatus).

A lens unit 101 includes a fixed lens group, a variable magnification lens group, a diaphragm, a variable magnification lens group, and a correction lens group for condensing light, and corrects an image formation position or adjusts a focus by controlling the components of the lens unit 101. The lens unit 101 forms an object image on an image formation surface of an image sensor 102.

The image sensor 102 converts light into electric charge to generate an imaging signal. The generated imaging signal is output to an image processing unit 103. The image sensor 102 is an imaging element such as a CCD image sensor or a CMOS image sensor. Note that the image sensor 102 may use a so-called dual-pixel type imaging element in which all pixels on the imaging surface are constituted by a pair of light-receiving elements and a pair of optical images formed by a microlens in each pixel can be converted into an electrical signal by the pair of light-receiving elements.

The image processing unit 103 converts the imaging signal input from the image sensor 102 into RAW data (RAW image). Thereafter, the image processing unit 103 performs RAW development processing including interpolation processing and image quality adjustment processing on the RAW data to generate image data in a YUV format corresponding to the RAW data, and stores the generated image data in a RAM 111.

Each of a crop circuit 104 and a crop circuit 105 performs crop processing on the image data in the YUV format (input image) stored in the RAM 111 to generate display image data, and stores the generated display image data in the RAM 111. The crop processing is processing of cutting out a partial area of an image. The entire image data in the YUV format stored in the RAM 111 may be stored in the RAM 111 as display image data.

An on-screen display (OSD) generation circuit 106 generates OSD data representing graphics such as various setting menus, titles, and time codes, and stores the OSD data in the RAM 111. The stored OSD data can be combined with the display image data stored in the RAM 111.

An enlargement circuit 107 (resizing circuit) is a circuit that resizes (enlarges or reduces) an image, and is used in a crop zoom function or a Magnify function. The resizing can be performed on the display image data stored in the RAM 111. Both the crop zoom function and the Magnify function are partial enlargement functions for cutting out any area from an image and resizing (enlarging) the cut-out area. The Magnify function is an auxiliary function of focus adjustment, and the crop zoom function is not an auxiliary function of focus adjustment. Note that a function of cutting out any area from an image but not enlarging the cut-out area is referred to as a simple crop function (crop function).

Settings of the functions can be changed by operating an operation switch group 109. The Magnify function is executed by operating an MAGN button of the operation switch group 109. An external output unit (output terminal) to use the Magnify function can be selected from external output units 114 and 115 by a user in advance in a menu. In response to the operation of the MAGN button, the Magnify function is executed on the input image that is input to the external output unit (output terminal) selected in the menu. In the Magnify function, when the MAGN button is operated, the Magnify function is executed with an AF area as an area to be cropped, and thereafter, a position and a size of the area to be cropped can be changed by a touch operation or the like. When the MAGN button is operated again while the Magnify function is being executed, the Magnify function is switched to OFF, and an output image of the external output unit (output terminal) to be subjected to the Magnify function is switched to an entire image. Note that, even when the external output unit (output terminal) using the Magnify function is switched in the menu, the Magnify function is switched to OFF. The crop function and the crop zoom function can be executed in response to an instruction to execute the crop function/crop zoom function from the menu. The crop function can change the position of the area to be cropped, but cannot change the size of the area. Furthermore, setting of the crop function can be performed for each of the external output units 114 and 115. In the crop zoom function, the position and size of the area to be cropped can be changed. The crop function may be switched to the crop zoom function in response to an instruction to change the size of the area to be cropped in the crop function. Furthermore, in the crop function/crop zoom function, in response to the area to be cropped being switched to the entire image, execution of the crop function/crop zoom function is stopped (function OFF), and the entire image is output.

In the above description, the settings of the Magnify function, the crop zoom function, and the crop function are changed by operating the operation switch group 109 of the imaging apparatus 100. However, when the imaging apparatus 100 is communicably connected to an external terminal by a communication unit (not illustrated) and the imaging apparatus 100 is configured to be controllable by the external terminal, the settings of the functions may be configured to be changeable by an operation on the external terminal.

A microcomputer 108 controls the entire imaging apparatus 100.

The operation switch group 109 includes a plurality of operation members that receive an operation from a user. For example, the operation switch group 109 includes switches for switching a mode of the imaging apparatus 100 between a plurality of modes including a camera mode for performing camera shooting, a playback mode for performing image playback, and a power off mode in which the power of the imaging apparatus 100 is turned off.

A ROM 110 is a flash ROM, and the ROM 110 stores various pieces of data including programs executed by the microcomputer 108. In addition, a partial area of the ROM 110 is used to store (back up) various pieces of information such as system state information.

The RAM 111 is a volatile memory used as a work memory. For example, the RAM 111 is used as a work memory by the microcomputer 108, the image processing unit 103, the crop circuits 104 and 105, and the OSD generation circuit 106.

Each of the external output units 114 and 115 is an output interface (output terminal) of a standard such as HDMI (registered trademark) or SDI, and outputs the display image data stored in the RAM 111 to the outside. Each of the external output units 114 and 115 can output the display image data with a quality such as, for example, 4K60P or 2K60P. In the present embodiment, the external output unit 114 is an output interface of HDMI and the external output unit 115 is an output interface of SDI, but the external output units may be interfaces of other standards. Furthermore, the external output units 114 and 115 may be output interfaces having the same standard.

An external display 116 is a display connected to the external output unit 114 (external device), and displays the display image data output from the external output unit 114.

An external switcher 117 is a switcher connected to the external output unit 115 (external device), and displays the display image data output from the external output unit 115.

FIG. 1 illustrates an example in which the external display 116 is connected to the external output unit 114 and the external switcher 117 is connected to the external output unit 115, but the external devices connected to the external output units 114 and 115 are not limited thereto. An external display may be connected to the external output unit 115 or an external switcher may be connected to the external output unit 114.

A bus 118 communicably connects the plurality of components of the imaging apparatus 100 to each other.

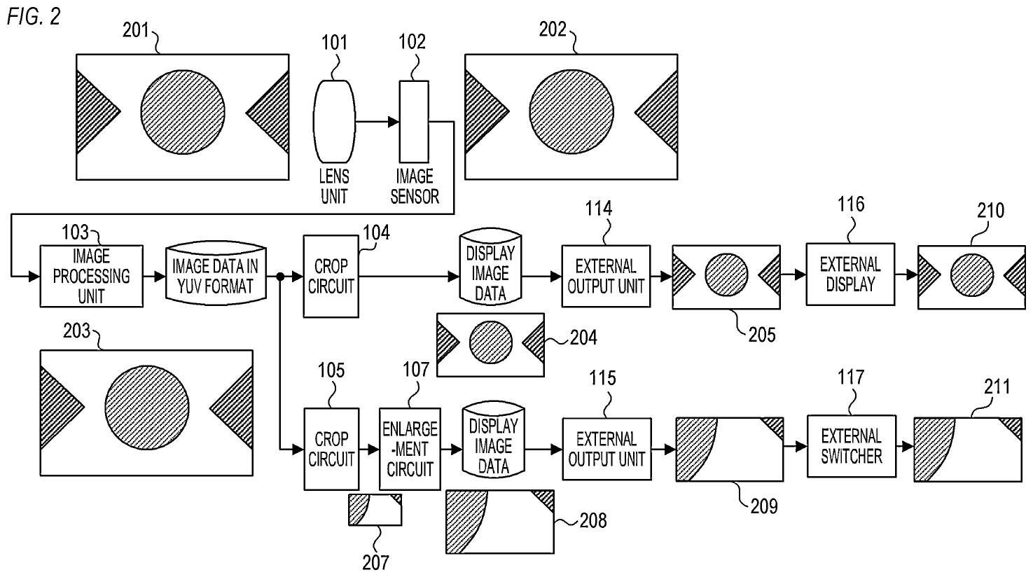

FIG. 2 is a schematic diagram illustrating a flow of image data in the imaging apparatus 100.

An object image 201 is formed on the image sensor 102 via the lens unit 101. The image sensor 102 photoelectrically converts the object image 201 to generate an imaging signal 202. The imaging signal 202 is input to the image processing unit 103. The image processing unit 103 performs various types of image processing on the imaging signal 202 to generate image data 203 in 4K and in the YUV format. Then, the image processing unit 103 stores, in the RAM 111, the image data 203 in 4K and in the YUV format.

The crop circuit 105 cuts out partial image data from the image data 203 in 4K and in the YUV format by crop processing, and stores the cut-out image data in the RAM 111 as display image data 207. The enlargement circuit 107 performs resizing (enlarging processing) on the display image data 207 to generate display image data 208 in 2K. The enlargement circuit 107 stores the display image data 208 in 2K in the RAM 111. The display image data 208 in 2K is output to the outside as display image data 209 via the external output unit 115, and is displayed as a video 211 by the external switcher 117.

At the same time, the crop circuit 104 converts the entire image data 203 in 4K and in the YUV format into display image data 204 in 2K, and stores the display image data 204 in the RAM 111. The display image data 204 in 2K is output to the outside as display image data 205 via the external output unit 114, and is displayed as a video 210 by the external display 116.

Although an example in which the enlargement circuit 107 is used with the crop circuit 105 is described, the enlargement circuit 107 can be used with the crop circuit 104 when the enlargement circuit 107 is not used with the crop circuit 105. When the enlargement circuit 107 is used with the crop circuit 104, the enlargement circuit 107 is disposed behind the crop circuit 104. The crop circuit 104 cuts out partial image data from the image data 203 in 4K and in the YUV format by crop processing, and stores the cut-out image data in the RAM 111. The enlargement circuit 107 performs resizing (enlargement processing) on image data obtained by crop processing of the crop circuit 104 to generate display image data in 2K.

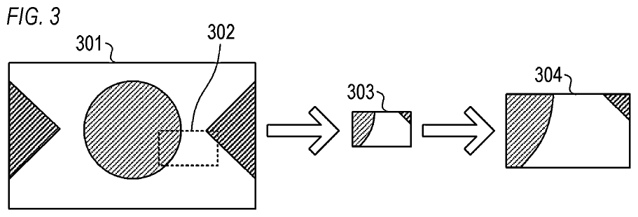

FIG. 3 is a schematic diagram illustrating a specific example of the partial enlargement function (the crop zoom function or the Magnify function). The crop circuit 105 (or the crop circuit 104) acquires image data in 4K and in the YUV format generated by the image processing unit 103, and cuts out an image 303 of an area 302 designated by a user from an input image 301 represented by the image data. The enlargement circuit 107 generates display image data 304 by enlarging the image 303.

As described above, the imaging apparatus 100 can use the enlargement circuit 107 with the crop circuit 104 or use the enlargement circuit 107 with the crop circuit 105. However, the imaging apparatus 100 includes only one enlargement circuit 107, and the enlargement circuit 107 cannot be used with both the crop circuit 104 and the crop circuit 105. Therefore, the imaging apparatus 100 can output the image data generated by the partial enlargement function from only one of the two external output units 114 and 115.

In the present embodiment, even if there is only one resizing circuit, it is possible to cause a user to feel as if a plurality of processing procedures each using the crop zoom function or the Magnify function are performed in parallel.

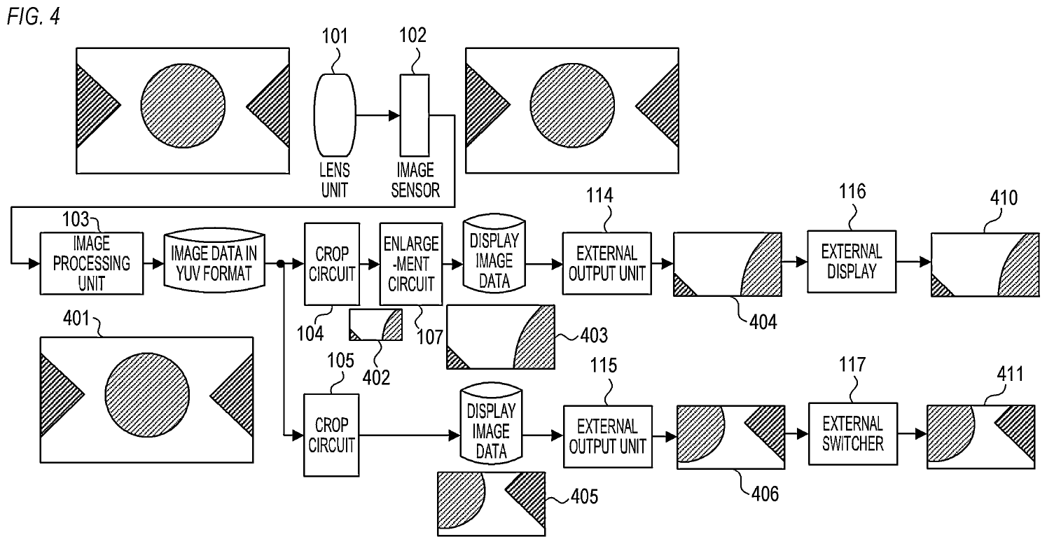

FIG. 4 is a schematic diagram illustrating a flow of image data in the imaging apparatus 100, and illustrates a case where transition is made from a state where the enlargement circuit 107 is used with the crop circuit 105 (the state of FIG. 2) to a state where the enlargement circuit 107 is used with the crop circuit 104.

The crop circuit 104 cuts out partial image data from image data 401 in 4K and in the YUV format by crop processing, and stores the cut-out image data in the RAM 111 as display image data 402. The enlargement circuit 107 performs resizing (enlarging processing) on the display image data 402 to generate display image data 403 in 2K. The enlargement circuit 107 stores the display image data 403 in 2K in the RAM 111. The display image data 403 in 2K is output to the outside as display image data 404 via the external output unit 114, and is displayed as a video 410 by the external display 116.

The crop circuit 105 cuts out image data of an area in 2K from the image data 401 in 4K and in the YUV format, and stores the cut-out image data in the RAM 111 as display image data 405. The display image data 405 in 2K is output to the outside as display image data 406 via the external output unit 115, and is displayed as a video 411 by the external switcher 117.

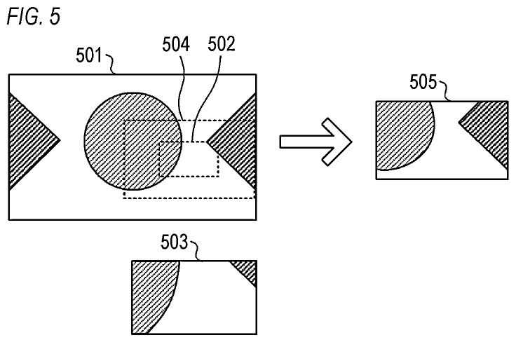

FIG. 5 is a schematic diagram illustrating a specific example of the processing of the crop circuit 105.

The crop circuit 105 acquires image data in the YUV format generated by the image processing unit 103. Here, it is assumed that, in the state (the state of FIG. 2) before the transition to the state of FIG. 4, the crop circuit 105 cuts out an image of an area 502 designated by a user from an input image 501 (401) represented by the acquired image data in the YUV format. Then, it is assumed that the enlargement circuit 107 enlarges the image of the area 502 to an image 503 in 2K.

In the state of FIG. 4, the crop circuit 105 cuts out, from the input image 501 (401), an area 504 in 2K (predetermined size) including the area 502 cut out by the crop circuit 105 in the state of FIG. 2, as an image 505 (406). As a result, in the state of FIG. 4, an angle of view of the image data output from the external output unit 115 can be made substantially the same as in the state of FIG. 2, and it is possible to cause a user to feel as if the partial enlargement function continues to be used for the image output from the external output unit 115.

Note that, when the size of the area 502 is larger than 2K, the entire input image 501 (4K image) may be output without cutting out the image by the crop circuit 105. Furthermore, when the size of the area 502 is smaller than HD, the crop circuit 105 cuts out an HD area including the area 502 from the input image 501. The sizes (resolutions) such as 4K, 2K, and HD are examples, and do not limit the present invention.

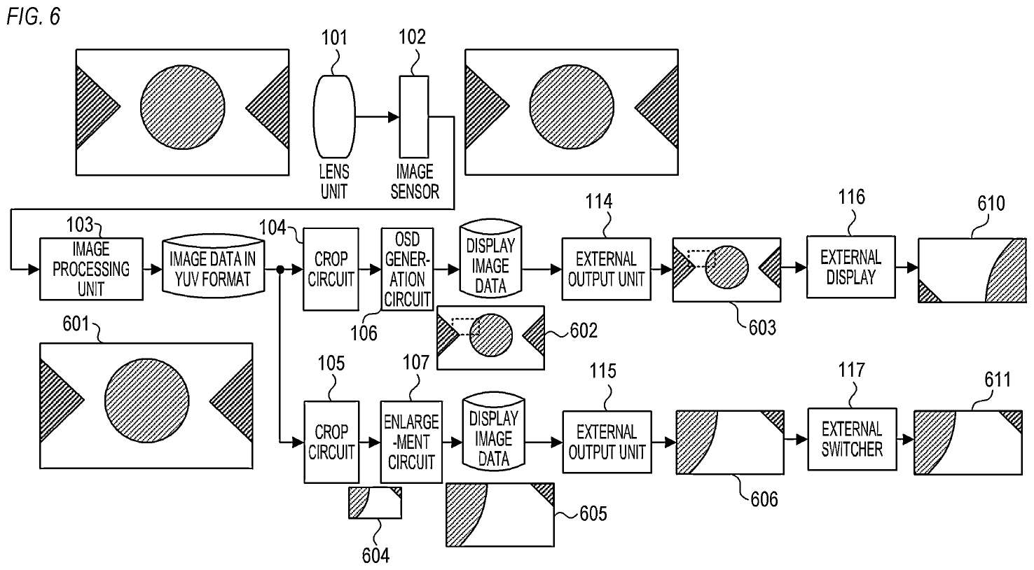

FIG. 6 is a schematic diagram illustrating a flow of image data in the imaging apparatus 100, and illustrates a case where transition is made from a state where the enlargement circuit 107 is used with the crop circuit 104 (the state of FIG. 4) to a state where the enlargement circuit 107 is used with the crop circuit 105.

The crop circuit 105 cuts out partial image data from image data 601 in 4K and in the YUV format by crop processing, and stores the cut-out image data in the RAM 111 as display image data 604. The enlargement circuit 107 performs resizing (enlarging processing) on the display image data 604 to generate display image data 605 in 2K. The enlargement circuit 107 stores the display image data 605 in 2K in the RAM 111. The display image data 605 in 2K is output to the outside as display image data 606 via the external output unit 115, and is displayed as a video 611 by the external switcher 117.

The crop circuit 104 converts the entire image data 601 in 4K and in the YUV format into image data in 2K. Here, the crop circuit 104 makes it possible to identify an area cut out by the crop circuit 104 in the state (the state of FIG. 4) before the transition to the state of FIG. 6 using the OSD generation circuit 106. The image data in 2K in which a partial area can be identified is stored in the RAM 111 as display image data 602. The display image data 602 in 2K is output to the outside as display image data 603 via the external output unit 114, and a video based on the display image data 602 in 2K is displayed by the external display 116. The external display 116 displays a video 610 obtained by enlarging an identifiable area based on the display image data 603 in 2K.

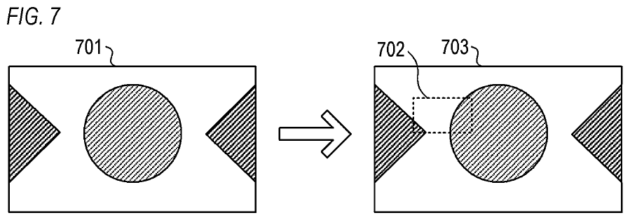

FIG. 7 is a schematic diagram illustrating a specific example of the processing of the crop circuit 104 and the OSD generation circuit 106. The crop circuit 104 acquires and outputs image data in the YUV format (input image 701 (601)) generated by the image processing unit 103. The OSD generation circuit 106 generates an image 703 (602) by superimposing a frame 702 indicating an area cut out by the crop circuit 104 in the state of FIG. 4 on the input image 701. As a result, an external device can automatically enlarge and display the area of the frame 702, and it is possible to cause a user to feel as if the partial enlargement function continues to be used for the image output from the external output unit 114.

Note that the external device may not automatically enlarge the area of the frame 702. For example, the external device may display the image 703 and may enlarge the area of the frame 702 in response to an enlargement instruction from a user. The user may designate an area to be enlarged during the enlargement instruction. By displaying the frame 702, the user can easily designate the area of the frame 702.

The image on which the frame 702 is superimposed only needs to include the area of the frame 702, and may be a part of the input image. For example, the crop circuit 104 may cut out a part of the input image 701 from the input image 701, and the OSD generation circuit 106 may superimpose the frame 702 on the area cut out by the crop circuit 104.

A method of making an area identifiable is not limited to the superimposition of the frame. For example, the luminance and color of an area may be changed, an area may be masked, a start point and an end point of an area may be emphasized, or metadata indicating the area (for example, coordinate information of a start point and an end point of an area) may be added to image data.

An area to be cut out by the crop circuit 104 after transition from the state of FIG. 4 to the state of FIG. 6 may be settable. Then, when an area not including the area of the frame 702 is set as an area to be cut out by the crop circuit 104, an image of the set area may be output to an external device while the frame 702 is not superimposed on the set area (without making the area of the frame 702 identifiable). The image of the set area may be output to the external device while the frame 702 is superimposed on the set area (after making the area of the frame 702 is identifiable).

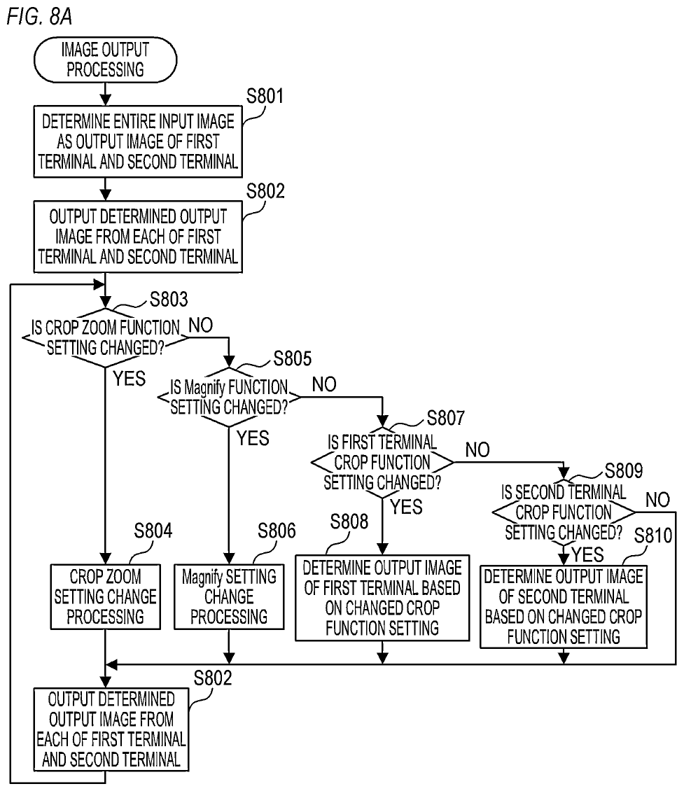

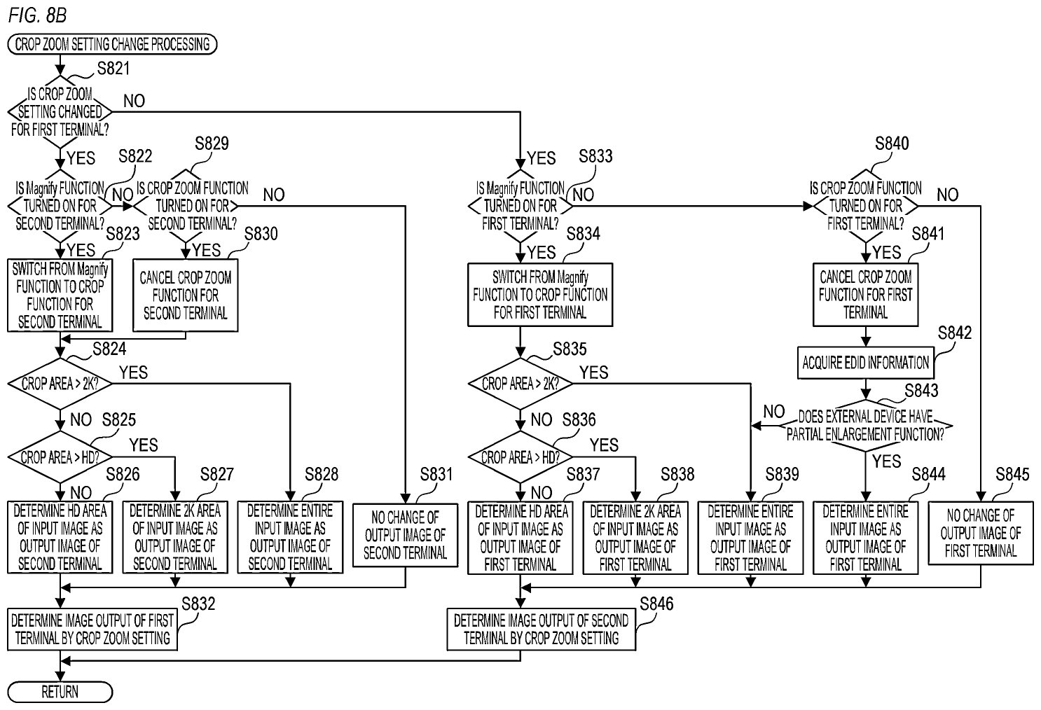

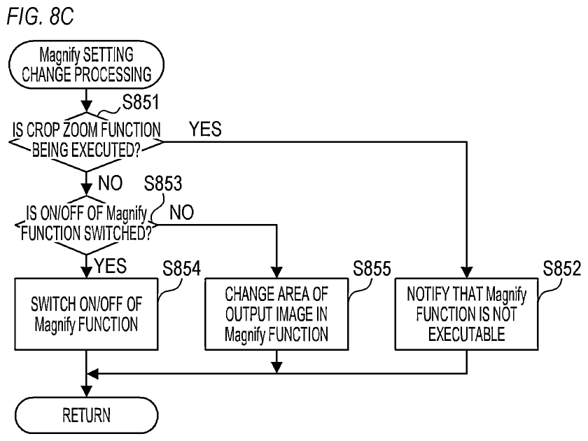

FIG. 8A is a flowchart of image output processing performed by the imaging apparatus 100. The image output processing in FIG. 8A is implemented by allowing the microcomputer 108 to load a program stored in the ROM 110 on the RAM 111 and execute the program. For example, when an external device is connected to the imaging apparatus 100, the microcomputer 108 starts the image output processing of FIG. 8A. Here, the external output unit 114 will be described as a first terminal, and the external output unit 115 will be described as a second terminal. The image output processing is processing in which various types of image processing are performed by the image processing unit 103 on the imaging signal generated by the image sensor 102, and image data in 4K and in the YUV format stored in the RAM 111 is output from the first terminal and the second terminal to the external device. In the image output processing, output images to be output from the first terminal and the second terminal are determined, display image data as an output image is generated from the image data 203 using the crop circuits 104 and 105, the enlargement circuit 107, and the like, and the display image data is stored in the RAM 111. Then, the external output unit 114 and the external output unit 115 perform processing of outputting the display image data stored in the RAM 111 from the first terminal and the second terminal, respectively.

In S801, the microcomputer 108 sets the entire image data 203 serving as an input image, which is an initial setting, as the output images of the first terminal and the second terminal. When the entire input image is determined as the output image, the image data 203 in 4K, which is the input image, becomes the output image without performing processing in the crop circuits 104 and 105 and the enlargement circuit 107. Then, in S802, the microcomputer 108 outputs the output image determined in S801 from the first terminal and the second terminal, which are the external output unit 114 and the external output unit 115, respectively.

In S803, the microcomputer 108 determines whether there was an operation of changing the setting of the crop zoom function, the processing proceeds to crop zoom setting change processing in S804 when it is determined that there was the operation of changing the setting of the crop zoom function, and the processing proceeds to S805 when it is determined that there was no such operation. The crop zoom setting change processing in S804 will be described later in detail with reference to FIG. 8B.

In S805, the microcomputer 108 determines whether there was an operation of changing the setting of the Magnify function, the processing proceeds to Magnify setting change processing in S806 when it is determined that there was the operation of changing the setting of the Magnify function, and the processing proceeds to S807 when it is determined that there was no such operation. The Magnify setting change processing in S806 will be described later in detail with reference to FIG. 8C.

In S807, the microcomputer 108 determines whether an operation of changing the setting of the crop function was performed for the output of the first terminal, the processing proceeds to S808 when it is determined that the operation of changing the setting of the crop function of the first terminal was performed, and the processing proceeds to S809 when it is determined that there was no such operation. In S808, the microcomputer 108 determines an output image according to the setting of the crop function changed in S807. When the crop function is changed to ON, the microcomputer 108 determines a crop area in 2K in the center of an input image in 4K as an output image, and when the crop area is changed, the microcomputer 108 determines the changed crop area as the output image. When the crop area is used as the output image, the microcomputer 108 performs control such that the determined crop area is cut out from the input image in 4K by the crop circuit 104 to generate display image data in 2K, and the display image data in 2K is output from the first terminal. When the crop function is changed to OFF, the microcomputer 108 determines an entire input image in 4K as the output image, and performs control to output the input image in 4K from the first terminal.

In S809, the microcomputer 108 determines whether an operation of changing the setting of the crop function was performed for the output of the second terminal, the processing proceeds to S810 when it is determined that the operation of changing the setting of the crop function of the second terminal was performed, and the processing proceeds to S811 without changing the determination of the output image when it is determined that there was no such operation. In S810, the same processing as that in S808 is executed for the second terminal. That is, the microcomputer 108 determines the output image in response to the setting of the crop function changed in S809. When the crop function is changed to ON, the microcomputer 108 determines a crop area in 2K in the center of an input image in 4K as an output image, and when the crop area is changed, the microcomputer 108 determines the changed crop area as the output image. When the crop area is used as the output image, the microcomputer 108 performs control such that the determined crop area is cut out from the input image in 4K by the crop circuit 105 to generate display image data in 2K, and the display image data in 2K is output from the second terminal. When the crop function is changed to OFF, the microcomputer 108 determines an entire input image in 4K as the output image, and performs control to output the input image in 4K from the second terminal.

In S811, the microcomputer 108 generates the output image determined by the processing in S801 to S810 by the processing of the image processing unit 103, the crop circuits 104 and 105, and the enlargement circuit 107. Then, the generated output image is output from the first terminal and the second terminal which are the external output unit 114 and the external output unit 115, respectively. Then, the microcomputer 108 repeatedly executes the processing in S803 to S811.

Next, the crop zoom setting change processing in S804 will be described with reference to FIG. 8B.

In S821, the microcomputer 108 determines whether the operation of changing the setting of the crop zoom function determined in S803 is an operation of changing the image to be output to the first terminal. When the determined operation is the operation of changing the setting of the crop zoom function of the first terminal, the processing proceeds to S822, and when the determined operation is the operation of changing the setting of the crop zoom function of the second terminal, the processing proceeds to S833.

In S822, the microcomputer 108 determines whether the Magnify function is ON, that is, whether the Magnify function was used for the second terminal. The processing proceeds to S823 when the Magnify function was used for the second terminal, and the processing proceeds to S829 when the Magnify function was not used for the second terminal. The processing proceeding to S823 is, for example, transition being made from the state of FIG. 2 to the state of FIG. 4.

In S823, the microcomputer 108 automatically switches the second terminal from the Magnify function to the simple crop function. That is, the second terminal is switched from the state where the enlargement circuit 107 is used for generating the display image data (output image) of the external output unit 115 (second terminal) as illustrated in FIG. 2 to the state where the enlargement circuit 107 is not used for generating the display image data of the external output unit 115 as illustrated in FIG. 4. By switching the second terminal to the simple crop function not to use the enlargement circuit 107, the enlargement circuit 107 can be used for the first terminal, and the output image can be generated by the crop zoom function for the first terminal.

In S829, the microcomputer 108 determines whether the crop zoom function is ON, that is, whether the crop zoom function was used for the second terminal. The processing proceeds to S830 when the crop zoom function was used for the second terminal, and the processing proceeds to S831 when the crop zoom function was not used for the second terminal. The processing proceeding to S830 is similar to the processing proceeding to S823, and for example, is transition being made from the state of FIG. 2 to the state of FIG. 4.

In S830, the microcomputer 108 automatically switches the second terminal from the crop zoom function to the simple crop function. That is, the second terminal is switched from the state where the enlargement circuit 107 is used for generating the display image data (output image) of the external output unit 115 (second terminal) as illustrated in FIG. 2 to the state where the enlargement circuit 107 is not used for generating the display image data of the external output unit 115 as illustrated in FIG. 4. By switching the second terminal to the simple crop function not to use the enlargement circuit 107, the enlargement circuit 107 can be used for the first terminal, and the output image can be generated by the crop zoom function for the first terminal.

In S831, the microcomputer 108 does not perform change of the output image of the second terminal, and the processing proceeds to S832.

In S824, the microcomputer 108 determines whether the size of an area (crop area) cut out by the crop circuit corresponding to the second terminal before switching to the simple crop function in S823 or S830 is larger than 2K (threshold value). The processing proceeds to S828 when the size of the crop area is larger than 2K, and the processing proceeds to S825 when the size of the crop area is not larger than 2K.

In S825, the microcomputer 108 determines whether the size of the area (crop area) cut out by the crop circuit corresponding to the second terminal before switching to the simple crop function in S823 or S830 is larger than HD (threshold value). The processing proceeds to S827 when the size of the crop area is larger than HD, and the processing proceeds to S826 when the size of the crop area is not larger than HD.

In S826, the microcomputer 108 determines the output image of the second terminal to cut out and output an HD area including the area (crop area) cut out by the crop circuit corresponding to the second terminal before switching to the simple crop function in S823 or S830. Then, the crop circuit 105 corresponding to the second terminal is controlled such that the determined output image is cut out.

In S827, the microcomputer 108 determines the output image of the second terminal to cut out and output an area in 2K including the area (crop area) cut out by the crop circuit corresponding to the second terminal before switching to the simple crop function in S823 or S830. Then, the crop circuit 105 corresponding to the second terminal is controlled such that the determined output image is cut out.

In S828, the microcomputer 108 determines the output image of the second terminal to output entire image data (input image) in 4K and in the YUV format. Then, the crop circuit 105 corresponding to the second terminal is controlled such that the determined output image is cut out. To output the entire input image, the input image in 4K and in the YUV format stored in the RAM 111 may be output by the external output unit 115 without involving the crop circuit.

Regarding the output image output from the second terminal, the image data output from the crop circuit 105 is stored in the RAM 111. The image data output from the crop circuit 105 is read from the RAM 111, is output to the outside via the external output unit 115, and is displayed by the external switcher 117.

In S832, the microcomputer 108 determines an output image for the first terminal according to the operation of changing the setting of the crop zoom function determined in S803. To execute the crop zoom function, the microcomputer 108 performs control such that display image data (output image) is generated from the image data (input image) in 4K and in the YUV format by using the crop circuit 104 and the enlargement circuit 107, as illustrated in FIG. 4, and the generated display image data is stored in RAM 111. That is, the crop circuit 104 is controlled to cut out partial image data from the image data (input image) in 4K and in the YUV format, and the enlargement circuit 107 is controlled to be used with the crop circuit 104. As a result, the crop circuit 104 cuts out partial image data from the image data in 4K and in the YUV format by the crop processing, and stores the cut-out image data in the RAM 111. The enlargement circuit 107 performs resizing (enlargement processing) on the image data cut out by the crop circuit 104 to generate display image data in 2K, and stores the display image data in 2K in the RAM 111. The display image data in 2K is output to the outside via the external output unit 114 by the processing in S811, and is displayed by the external display 116.

After the crop zoom setting change processing in S804 is completed in S832, the processing proceeds to S811 in FIG. 8A.

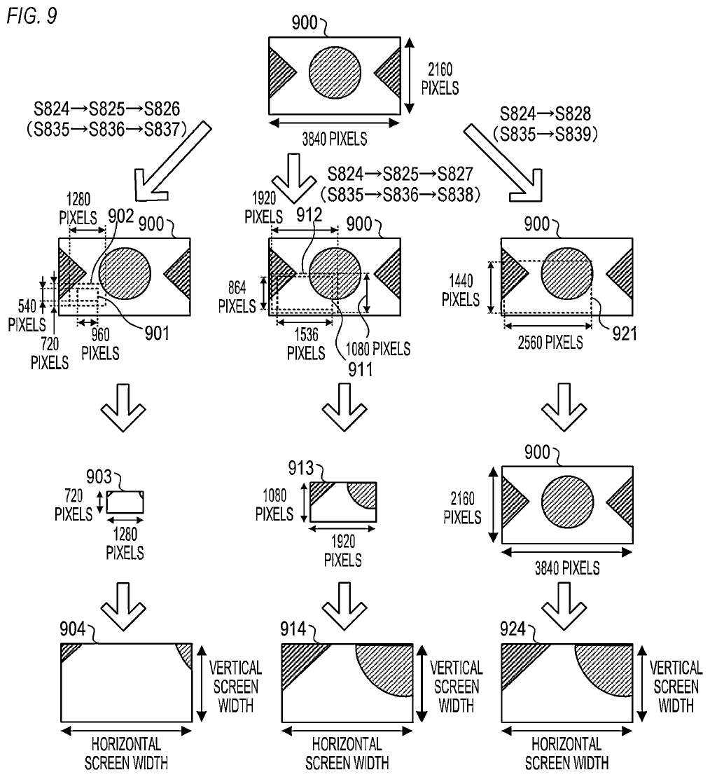

FIG. 9 is a schematic diagram illustrating a specific example of an operation of the imaging apparatus 100. It is assumed that an input image 900 is generated by the image processing unit 103.

When an area (crop area) cut out by the crop circuit 105 before switching to the simple crop function is an area 901 smaller than HD, the processing proceeds from S824 to S825, and the processing proceeds from S825 to S826. Under the control in S826, the crop circuit 105 cuts out an area 902 in HD including the area 901 from the input image 900 and outputs the cut-out area as an image 903. Then, under the control in S811, the image 903 is displayed as a video 904 on the external switcher 117.

When the area (crop area) cut out by the crop circuit 105 before switching to the simple crop function is an area 911 larger than HD and smaller than 2K, the processing proceeds from S824 to S825, and the processing proceeds from S825 to S827. Under the control in S827, the crop circuit 105 cuts out an area 912 in 2K including the area 911 from the input image 900 and outputs the cut-out area as an image 913. Then, under the control in S811, the image 913 is displayed as a video 914 on the external switcher 117.

When the area (crop area) cut out by the crop circuit 105 before switching to the simple crop function is an area 921 larger than 2K, the processing proceeds from S824 to S828. Under the control in S828, the crop circuit 105 outputs the entire input image 900. Then, under the control in S811, the input image 900 is displayed as a video 924 on the external switcher 117.

According to the above operation, an angle of view of the image output from the second terminal can be substantially maintained from before switching to the simple crop function (when the crop zoom function or the Magnify function was used). As a result, it is possible to maintain a state in which the user can easily perform confirmation and adjustment of the focus.

Next, processing in the case of the operation of changing the setting of the crop zoom function of the second terminal (S833 to S846) will be described. The processing basically corresponds to the processing in the case of the operation of changing the setting of the crop zoom function of the second terminal (S822 to S832). In the processing in S822 to S832, processing is executed such that the first terminal and the second terminal are switched to each other, and the crop circuit 104 corresponding to the first terminal and the crop circuit 105 corresponding to the second terminal are also switched to each other. The processing in which only the switching between the terminal and the crop circuit is performed will not be described as corresponding processing, and portions different from S822 to S832 will be mainly described.

S833 to S841 correspond to S822 to S830, respectively, and S845 and S846 correspond to S831 and S832, respectively. After canceling the crop zoom function of the first terminal in S841, the processing proceeds to S842.

In S842, the microcomputer 108 acquires, from the external device connected to the first terminal and via the first terminal, EDID information including information on whether the external device has a function of enlarging an image (partial enlargement function). The EDID information is information that can be acquired in the HDMI standard. In the present embodiment, the first terminal is a terminal compliant with the HDMI standard, and the second terminal is not a terminal compliant with the HDMI standard. Therefore, when the operation of changing the setting of the crop zoom function of the second terminal is performed and the crop zoom function of the first terminal is canceled, the processing in S842 to S844 is executed.

Note that the method of acquiring the information on the external device is not limited to the above-described method, and other information may be used instead of the EDID information of the HDMI standard for information on whether the external device has the function of enlarging an image. For example, the information on the external device may be acquired from a manufacturer site via a network. If the information on whether the external device has the function of enlarging an image can be acquired, the processing corresponding to S842 to S844 may be executed even when the crop zoom function of the second terminal is canceled in S830. The information of the external device may be stored in advance in the imaging apparatus 100.

In S843, the microcomputer 108 determines whether the external device connected to the first terminal has the function of enlarging an image (partial enlargement function) according to the information acquired in S842. The processing proceeds to S844 when the external device has the partial enlargement function, and the processing proceeds to S839 when the external device does not have the partial enlargement function. When the external device does not have the partial enlargement function, the processing may proceed to S835.

In S844, the microcomputer 108 specifies an area output to the first terminal before the crop zoom function is canceled in S841, that is, an area (crop area) cut out by the crop circuit 104 corresponding to the first terminal. Then, control is performed to output image data in 4K and in the YUV format (input image) such that the specified crop area can be identified. The microcomputer 108 controls the crop circuit 104 corresponding to the first terminal to output the entire image data (input image) in 4K and in the YUV format. Then, the microcomputer 108 controls the OSD generation circuit 106 such that a frame indicating the crop area (crop frame) is superimposed on the image output from the crop circuit 104 corresponding to the first terminal.

In S844, the crop circuit 104 is controlled to the output image data (input image) in 4K and in the YUV format. Then, the OSD generation circuit 106 is controlled to superimpose the crop frame on the image output from the crop circuit 104. As a result, display image data representing the image on which the crop frame is superimposed is stored in the RAM 111. The stored display image data is output to the outside via the external output unit 114 and is displayed by the external display 116 by the processing in S811.

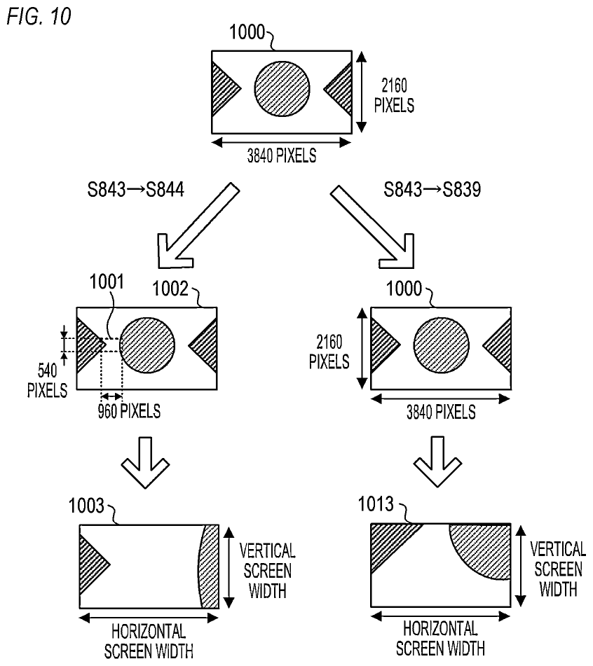

FIG. 10 is a schematic diagram illustrating a specific example of an operation of the imaging apparatus 100. It is assumed that an input image 1000 is generated by the image processing unit 103.

The processing proceeds from S843 to S844 when the external display 116 has the partial enlargement function. An image 1002 in which a crop frame 1001 is superimposed on the input image 1000 is generated under the control in S844. Here, the crop frame is a frame indicating an area output from the first terminal before the crop zoom function of the first terminal is canceled in S841, that is, an area (a crop area) cut out by the crop circuit 104. Then, under the control in S811, the image 1002 is output to the external switcher 117. The external display 116 displays an image 1003 in which the crop area (the area of the crop frame 1001) is enlarged.

The processing proceeds from S843 to S839 when the external display 116 does not have the partial enlargement function. Under the control in S839, the crop circuit 104 outputs the entire input image 1000. Then, under the control in S811, the input image 1000 is displayed as a video 1013 on the external display 116.

According to the above operation, when the external device connected to the first terminal has the partial enlargement function, the external device can display a video having the same angle of view as that before the crop zoom function of the first terminal is canceled in S841.

Next, Magnify setting change processing in S806 will be described with reference to FIG. 8C.

In S851, the microcomputer 108 determines whether the crop zoom function is being executed. That is, it is determined whether the enlargement circuit 107 is being used by executing the crop zoom function in the first terminal or the second terminal. The processing proceeds to S852 when it is determined that the crop zoom function is being used, and the processing proceeds to S853 when it is determined that the crop zoom function is not being used.

In S852, the microcomputer 108 notifies a user that the Magnify function cannot be executed because the crop zoom function is being executed. The notification is made by, for example, displaying the content of the notification on a display unit (not illustrated) of the imaging apparatus. In the present embodiment, the crop zoom function is prioritized over the Magnify function. Therefore, when the crop zoom function is already being executed, the Magnify function cannot be executed. When the crop zoom function is being performed on the same terminal as a terminal set as a Magnify function target, the crop zoom function may be switched to the Magnify function.

In S853, the microcomputer 108 determines whether the operation of changing the setting of the Magnify function determined in S805 is performed by pressing the MAGN button and whether the operation is a switching operation of ON/OFF of the Magnify function. The processing proceeds to S854 when it is determined that the operation is the switching operation of ON/OFF of the Magnify function, and the processing proceeds to S855 when it is determined that the operation is not the switching operation of ON/OFF of the Magnify function but an operation of changing the position or size of the crop area in the Magnify function.

In S854, the microcomputer 108 performs switching processing of ON/OFF of the Magnify function. Regarding a terminal set as a Magnify function target in the menu, switching is performed between outputting an image using the Magnify function and outputting the entire input image. When switching to outputting an image using the Magnify function, the microcomputer 108 determines an AF area as an output image. Then, a crop circuit of the crop circuits 104 and 105, which corresponds to a terminal serving as a Magnify function target, is controlled to cut out an area set as the AF area as a crop area. The enlargement circuit 107 is controlled to resize the image cut out by the crop circuit and generate display image data in 2K. When the Magnify function is switched to OFF, the microcomputer 108 controls the crop circuit corresponding to the terminal serving as a Magnify function target to output entire image data (input image) in 4K and in the YUV format. To output the entire input image, the input image in 4K and in the YUV format stored in the RAM 111 may be output without involving the crop circuit.

In S855, the microcomputer 108 performs processing of changing the output image according to the operation of changing the position or size of the area in the Magnify function determined in S805 and S853. That is, the crop circuit corresponding to the terminal serving as a Magnify function target is controlled to change the crop area to the position/size changed by the change operation. The enlargement circuit 107 is controlled to resize the image cut out by the crop circuit and generate display image data in 2K.

After the processing in S854 or S855 is executed, the Magnify setting change processing ends and the processing returns to FIG. 8A, and by the processing in S811, the display image data generated by the control in S854 or S855 is output to the outside from the terminal set as a Magnify function target. When the processing in S852 is executed, change of the output image is not performed in the Magnify setting change processing. After the processing in S852, the Magnify setting change processing ends and the processing returns to FIG. 8A, and by the processing in S811, the display image data of the same area as that before the Magnify setting change processing is output from the terminal of the Magnify function target to the outside.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

For example, when the crop zoom setting is changed, different processing is performed on a terminal that was not changed depending on whether the Magnify function is used and whether the crop zoom function is used, but different processing may not be performed. Regarding the terminal that was not changed in either case, the processing may proceed to S824/S835 after switching to the simple crop function, or the processing may proceed to S842 after switching to the simple crop function. When the crop zoom setting is changed, the processing may proceed to S841 when the Magnify function is used for the terminal that was not changed, and the processing may proceed to S823/S834 when the crop zoom function is used. In addition, the present invention may be applied to an apparatus that performs cutout processing and resizing processing by a general-purpose circuit or software processing, instead of an apparatus having two crop circuits and one resizing circuit. The effect of the present invention is particularly exhibited when a plurality of resizing processing cannot be executed simultaneously because the resizing processing has a high processing load. Furthermore, in the above-described embodiment, a description has been given as to a case where two functions of the Magnify function and the crop zoom function are provided as functions of cutting out a partial area of an input image and then resizing the cut-out partial area to generate an output image. However, the Magnify function and the crop zoom function may be treated as the same function.

Furthermore, in the above-described embodiment, a case where the present invention is applied to the imaging apparatus (digital camera) is described as an example, but the present invention is not limited to the example, and any electronic apparatus capable of inputting and outputting an image (image processing apparatus) can be applied. For example, the present invention is applicable to a personal computer, a PDA, a mobile-phone terminal, a portable image viewer, a printer apparatus, a digital photo frame, a music player, a video game machine, an electronic book reader, and the like. The present invention is further applicable to, for example, a video player, a display device (including a projector), a tablet terminal, a smartphone, an AI speaker, a home electrical appliance, an on-vehicle apparatus, and the like.

According to the present invention, even if the resizing processing is limited, for example, it is possible to appropriately execute processing that requires cutout processing and resizing processing such as a crop zoom function or a Magnify function.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-014417, filed on Feb. 1, 2024, which is hereby incorporated by reference herein in its entirety.

What is claimed is:

1. An image processing apparatus comprising:
a first crop circuit capable of cutting out a partial area of an input image and outputting the cut-out partial area;
a second crop circuit capable of cutting out the partial area of the input image and outputting the cut-out partial area; and
an enlargement circuit configured to be used with one of the first crop circuit and the second crop circuit, and enlarge the area cut out by the first crop circuit or the second crop circuit,
wherein, in a case where transition is performed from a first state where the enlargement circuit is used with the first crop circuit to a second state where the enlargement circuit is used with the second crop circuit, the first crop circuit cuts out, from the input image, an area having a predetermined size and including an area cut out by the first crop circuit in the first state, and outputs the cut-out area having the predetermined size.

2. The image processing apparatus according to claim 1, wherein
in a case where transition is performed from the first state to the second state, if a size of the area cut out by the first crop circuit in the first state is larger than a first threshold value, the first crop circuit outputs the input image.

3. The image processing apparatus according to claim 2, wherein
in a case where transition is performed from the first state to the second state,
if the size of the area cut out by the first crop circuit in the first state is smaller than the first threshold value and larger than a second threshold value, the first crop circuit cuts out an area having a first size from the input image and outputs the cut-out area having the first size, and
if the size of the area cut out by the first crop circuit in the first state is smaller than the second threshold value, the first crop circuit cuts out an area having a second size smaller than the first size from the input image and outputs the cut-out area having the second size.

4. The image processing apparatus according to claim 1, further comprising
a control circuit configured to perform control to issue a notification indicating that a second function is not executable in a case where the enlargement circuit is being used with the first crop circuit for a first function and an instruction is given to use the enlargement circuit with the second crop circuit for the second function.

5. The image processing apparatus according to claim 1, wherein
the first crop circuit performs different processing between (1) a case where transition is performed from a first state where the enlargement circuit is used with the first crop circuit for a first function to the second state and (2) a case where transition is performed from a first state where the enlargement circuit is used with the first crop circuit for a second function to the second state.

6. An image processing apparatus comprising:
a first crop circuit capable of cutting out a partial area of an input image and outputting the cut-out partial area;
a second crop circuit capable of cutting out the partial area of the input image and outputting the cut-out partial area; and
an enlargement circuit configured to be used with one of the first crop circuit and the second crop circuit, and enlarge the area cut out by the first crop circuit or the second crop circuit,
wherein, in a case where transition is performed from a first state where the area cut out by the first crop circuit is enlarged by the enlargement circuit and output to an external device to a second state where the enlargement circuit is used with the second crop circuit, the first crop circuit outputs an image including the area cut out by the first crop circuit in the first state such that the area is identifiable.

7. The image processing apparatus according to claim 6, wherein
in a case where transition is performed from the first state to the second state, the first crop circuit outputs the input image such that the area cut out by the first crop circuit in the first state is identifiable.

8. The image processing apparatus according to claim 6, wherein
in a case where transition is performed from the first state to the second state, if the external device does not have a function of enlarging an image, the first crop circuit outputs the image including the area cut out by the first crop circuit in the first state without the area being identifiable.

9. The image processing apparatus according to claim 8, further comprising
an acquisition circuit configured to acquire information on whether the external device has the function of enlarging the image.

10. The image processing apparatus according to claim 9, wherein
the acquisition circuit acquires, from the external device, EDID information including the information on whether the external device has the function of enlarging the image.

11. The image processing apparatus according to claim 6, wherein
an area to be cut out by the first crop circuit after transition is performed from the first state to the second state is settable,
in a case where transition is performed from the first state to the second state, if an area not including the area cut out by the first crop circuit in the first state is set as the area to be cut out by the first crop circuit after transition is performed from the first state to the second state, the first crop circuit outputs an image of the set area without the area cut out by the first crop circuit in the first state being identifiable, and
in a case where transition is performed from the first state to the second state, if an area including the area cut out by the first crop circuit in the first state is set as the area to be cut out by the first crop circuit after transition is performed from the first state to the second state, the first crop circuit outputs the image of the set area such that the area cut out by the first crop circuit in the first state is identifiable.

12. A control method of an image processing apparatus including a first crop circuit capable of cutting out a partial area of an input image and outputting the cut-out partial area, a second crop circuit capable of cutting out the partial area of the input image and outputting the cut-out partial area, and an enlargement circuit configured to be used with one of the first crop circuit and the second crop circuit, and enlarge the area cut out by the first crop circuit or the second crop circuit, the control method comprising:
controlling a state of the image processing apparatus such that transition is performed from a first state where the enlargement circuit is used with the first crop circuit to a second state where the enlargement circuit is used with the second crop circuit; and
controlling processing of the first crop circuit such that in a case where transition is performed from the first state to the second state, the first crop circuit cuts out, from the input image, an area having a predetermined size and including an area cut out by the first crop circuit in the first state, and outputs the cut-out area having the predetermined size.

13. A control method of an image processing apparatus including a first crop circuit capable of cutting out a partial area of an input image and outputting the cut-out partial area, a second crop circuit capable of cutting out the partial area of the input image and outputting the cut-out partial area, and an enlargement circuit configured to be used with one of the first crop circuit and the second crop circuit, and enlarge the area cut out by the first crop circuit or the second crop circuit, the control method comprising:
controlling a state of the image processing apparatus such that transition is performed from a first state where the area cut out by the first crop circuit is enlarged by the enlargement circuit and output to an external device to a second state where the enlargement circuit is used with the second crop circuit; and
controlling processing of the first crop circuit such that in a case where transition is performed from the first state to the second state, the first crop circuit outputs an image including the area cut out by the first crop circuit in the first state such that the area is identifiable.

14. A non-transitory computer readable medium that stores a program, wherein the program causes a computer to execute a control method of an image processing apparatus including a first crop circuit capable of cutting out a partial area of an input image and outputting the cut-out partial area, a second crop circuit capable of cutting out the partial area of the input image and outputting the cut-out partial area, and an enlargement circuit configured to be used with one of the first crop circuit and the second crop circuit, and enlarge the area cut out by the first crop circuit or the second crop circuit, the control method comprising:
controlling a state of the image processing apparatus such that transition is performed from a first state where the enlargement circuit is used with the first crop circuit to a second state where the enlargement circuit is used with the second crop circuit; and
controlling processing of the first crop circuit such that in a case where transition is performed from the first state to the second state, the first crop circuit cuts out, from the input image, an area having a predetermined size and including an area cut out by the first crop circuit in the first state, and outputs the cut-out area having the predetermined size.

15. A non-transitory computer readable medium that stores a program, wherein the program causes a computer to execute a control method of an image processing apparatus including a first crop circuit capable of cutting out a partial area of an input image and outputting the cut-out partial area, a second crop circuit capable of cutting out the partial area of the input image and outputting the cut-out partial area, and an enlargement circuit configured to be used with one of the first crop circuit and the second crop circuit, and enlarge the area cut out by the first crop circuit or the second crop circuit, the control method comprising:
controlling a state of the image processing apparatus such that transition is performed from a first state where the area cut out by the first crop circuit is enlarged by the enlargement circuit and output to an external device to a second state where the enlargement circuit is used with the second crop circuit; and
controlling processing of the first crop circuit such that in a case where transition is performed from the first state to the second state, the first crop circuit outputs an image including the area cut out by the first crop circuit in the first state such that the area is identifiable.
